(19) United States
(12) Patent Application Publication
(10) Pub. No.: US 2014/0365366 A1
(43) Pub. Date: Dec. 11, 2014

(54) SYSTEM AND DEVICE FOR RECEIVING AUTHENTICATION CREDENTIALS USING A SECURE REMOTE VERIFICATION TERMINAL

(71) Applicant: Apriva, LLC, Scottsdale, AZ (US)

(72) Inventor: Rinaldo A. Spinella, Medford, MA (US)

(21) Appl. No.: 13/910,742

(22) Filed: Jun. 5, 2013

(51) Int. Cl. G06Q 20/40

(52) U.S. Cl. CPC G06Q 20/4012
USPC 705/44

(57) ABSTRACT

The present invention relates generally to a system and device for expanding the utility of remote payment technologies by way of a remote transaction card reader and keypad for the entry of an account PIN. More specifically, the device moves much of the functionality required for mobile payments away from a mobile card accepting appliance (e.g., a smartphone equipped with a card reader) to the disparate device. This arrangement isolates the processes of reading a transaction card a verifying an entered PIN into a secure tamper resistant device that communicates with a communication device (e.g., smartphone) by way of a secure channel on a wireless network. This arrangement provides for greater security and convenience for processing credit card and debit card based transactions, as the collection and processing of sensitive data is separated from the commercially available smartdevice, which inherently lacks sufficient security.

### FIELD OF THE INVENTION

The disclosed system and device facilitates remote use of credit/debit cards or any other transaction device requiring entry and authentication of a personal identifier. More specifically, a remote verification terminal communicates with a smartdevice (e.g., smartphone, tablet) to locally facilitate a transaction card and cardholder identity verification process. Based on the verification process, an authorization request is transmitted to a payment gateway by a connected card accepting appliance.

### BACKGROUND

Mobile payment technologies have allowed merchants to facilitate financial transactions without regard to geographical boundaries. Equipped with a networked wireless device, merchants and individuals are able to efficiently collect transaction card information, send the information to a payment processor, and receive an authorization message from a payment gateway. In its most common form, a mobile payment includes collecting credit/debit card information by way of a smartphone, which is equipped with a magnetic stripe reader and proprietary processing software.

Mobile payments technology has significantly expanded the base of merchants who are able to accept credit/debit card payments. However, limitations remain in ensuring that a credit/debit card transaction is not fraudulent. These limitations are not unique to mobile payments; however, the impact of fraudulent charge transactions has increased relative to the rapidly expanding base of merchants accepting credit/debit card payments due to the implementation of mobile payment technologies.

Conventional credit/debit card transactions include customer presentation of a credit/debit card having encoded credentials for authorizing payment to a merchant from funds available in a credit/debit account. In most cases, the credentials, along with account identifying information is encoded in a magnetic stripe that is located on the backside of the transaction card. In more recent implementations, this information is stored within a microprocessor and memory equipped smartcard. In either case, the physical presence of the transaction card is verified by a card reader to facilitate a “card present” transaction. Card present transactions are generally more secure because the customer's possession of the physical transaction card is ensured. While less secure, “card not present” transactions, such as those resulting from an Internet purchase, for example, still provide a degree of security by requiring the customer to enter information in addition to the credit/debit card number. Requiring the customer to enter additional card information (e.g., customer's name, billing address, expiration date, security code, etc.), reduces the incidents of fraudulent transactions by unauthorized purchasers having possession of a credit/debit card number alone.

To further secure transaction card purchase transactions, a secondary verification process was introduced, intended to ensure that the person presenting the transaction card or transaction card information is the authorized account owner. This secondary verification requires the purchaser to enter a Personal Identification Number (PIN) that uniquely corresponds to a presented transaction card. While the encoded transaction card verifies the presence of a valid transaction card (i.e., what you have), the PIN helps to verify that the transaction card is presented by the legitimate owner of the transaction card (i.e., what you know). This type of transaction is generally described as a “PIN Debit” transaction, but could also be used with specific credit cards.

Mobile payments have conventionally been limited to facilitating credit card transactions, wherein a smartphone, for example, is equipped with a magnetic stripe reader. The reader equipped smartphone allows the merchant to “swipe” the card through the reader in much the same way as the traditional storefront merchant. However, due to security concerns among other factors, mobile payment technologies have not included the necessary hardware and software for facilitating secure PIN based card transactions. For example, allowing a purchaser to enter his/her PIN via the merchant's smartphone keypad presents further opportunities for a PIN to become compromised. Moreover, many merchants may be resistant to handing over their smartphone to customers for PIN entry.

Due to the limitations outlined above, there is a need for an alternative payment processing system, wherein a merchant can utilize their preferred smartdevice and network carrier to facilitate both credit card and debit card transactions without being required to temporarily surrender their smartdevice to a customer for presentation of a transaction card and facilitating PIN entry. Moreover, a need exists for a system and device configured to protect sensitive transaction card information and a PIN from being compromised by isolating the PIN validation process such that the PIN is never transmitted over a network where it may be compromised. Specifically, the system should provide merchants with a simple and reliable method to accept and process PIN based transaction cards remotely without compromising security standards. As a result, the system and device should provide increased data security, improved efficiency, reduced operating costs, and enhanced customer experience.

### SUMMARY OF THE INVENTION

In general, the invention overcomes the limitations and problems of prior art systems by providing a system and device that is configured to perform a two-tier validation process for verifying a transaction card and verifying the identity of the cardholder. The disclosed remote terminal reports encrypted transaction card information and verification status to a smartdevice over a secure communications channel.

More specifically, the remote verification terminal accepts a PIN that is entered by a cardholder and securely processes the PIN to create authentication credentials. The credentials are validated against information collected from a memory portion (e.g., magnetic stripe, smartcard) of the corresponding transaction card. The memory or encoded portion of the transaction card is interrogated by a reader corresponding to the transaction card type.

The disclosed remote verification terminal isolates the processes of reading a transaction card, accepting the PIN from the cardholder, and validating the PIN by comparing it to data read from the transaction card or by adding it to the secure transaction. In various embodiments, the disclosed remote verification terminal comprises either a physical keypad or screen-based graphical interface for convenient entry of a PIN by a user. The remote verification terminal further includes various hardware components disposed within a security hardened case.

The PIN verification process validates the identity of the cardholder without requiring the PIN data to leave the secure confines of the remote verification terminal, or by securely encrypting it before it leaves the secure confines. On successful verification, transaction card information that is required to construct a transaction authorization request is encrypted at the remote verification terminal before being transmitted to a connected smartdevice. The smartdevice decrypts the transaction card information, constructs a transaction authorization request based on the transaction card information and purchase information, and securely sends it over a network to a payment gateway. The payment gateway returns either an authorization message or a decline message based on verification of the transaction card and the purchase information in light of the credit or banking account identified by the transaction card information.

In one embodiment, the hardware components of the remote verification terminal are configured to read data from a transaction card, collect PIN data resulting from user interaction with the keypad, verify the identity of the cardholder by comparing the PIN to information read from the transaction card, execute an encryption algorithm for securing the data for transport, and transporting the data over a peer-to-peer network to a receiving smartdevice. The remote verification terminal hardware is further configured to receive requests and/or messages from the smartdevice by way of a secure connection. A request may include, for example, a request for the remote verification terminal to prompt the cardholder to swipe a credit/debit card and enter his/her PIN. A message may comprise a validation success or failure message based on an authorization or decline message received from a payment gateway.

In another embodiment, the two-tiered validation process is divided between the smartdevice and the remote verification terminal. Hardware components within the remote verification terminal are configured to receive encrypted transaction card data from a smartdevice, wherein the smartdevice reads or captures the transaction card data based on a transaction card. The remote verification terminal includes hardware and software configured to decrypt the received encrypted data and prompt for PIN entry from the transaction card holder, A PIN entered at the remote verification terminal is processed and is validated against the decrypted data, ensuring that the PIN accurately corresponds to the transaction card. The remote verification terminal further includes hardware and software for configuring a validation message and for transmitting the validation message over a network connection with the smartdevice.

### BRIEF DESCRIPTION OF EXEMPLARY DRAWINGS

A more complete understanding of the present invention may be derived by referring to the detailed description and claims when considered in connection with the Figures, wherein like reference numbers refer to similar elements throughout the Figures, and

FIG. 1 is a system diagram illustrating system components for a remote verification terminal in accordance with an exemplary embodiment of the present invention;

FIG. 2 is a network diagram illustrating the various devices and systems used in facilitating secure mobile transaction card payments with a remote verification terminal accordance with an exemplary embodiment of the present invention; and

FIG. 3 is a device diagram illustrating a handheld remote verification terminal in accordance with an exemplary embodiment of the present invention.

### DETAILED DESCRIPTION OF EXEMPLARY EMBODIMENTS

In general, the present invention uniquely provides an efficient and highly secure means for facilitating identity verification and transaction authorization. More specifically, the disclosed system securely isolates transaction card and cardholder identity verification features within a highly secure and tamper resistant remote verification terminal. Isolation of highly sensitive information ensures that verification credentials do not leave the confines of the remote verification terminal, thereby securing this information from exposure to network eavesdroppers. Accordingly, and in one embodiment, the remote verification terminal removes the transaction card and cardholder identity verification features from the smartdevice, where it commonly resides in today's mobile payment systems. The remote verification terminal further expands mobile payment features by providing a secure and convenient means for facilitating credit/debit card transactions.

As used herein, the terms “cardholder,” “consumer,” “customer”, “user”, or “accountholder” may be used interchangeably with each other, and each shall mean any person, entity, machine, hardware, software, and/or business that enters into a financial agreement with a business or merchant. Furthermore, the terms “business” or “merchant” may be used interchangeably with each other and shall mean any person, entity, machine, hardware, software, or business that enters into a financial agreement with a cardholder. Further still, the merchant may be any person, entity, software, and/or hardware that is a provider, broker, and/or any other entity in the distribution chain of goods or services.

As used herein, a “card accepting appliance” or “smartdevice” may comprise any hardware, software, or combination thereof, configured to invoke and/or facilitate communication and/or transactions over a carrier network. More specifically, it should be noted that the smartdevice may be embodied as any combination of hardware and/or software components configured to interact with various other hardware and/or software components to facilitate the disclosed transaction card and cardholder identity verification and electronic payment features. For example, the smartdevice may include a cellular telephone equipped with a microprocessor and memory for executing machine readable instructions. Moreover, practitioners will appreciate that the terms “smartdevice”, “communication device”, “smart phone”, “mobile phone”, and “cell phone” may be used interchangeably without departing from the scope of the invention.

As used herein, a “keypad”, “keys”, or “graphical interface” comprises any hardware, software, or combination thereof, which is configured to accept an input by any of the parties discussed herein. An “input” may be defined as, for example, key presses on a Physical keyboard, button selection on a touch screen, a verbal command, a biometric sample, and the like. A biometric sample may include, for example, a fingerprint, iris scan, facial feature recognition, and the like (i.e., what you are). However, practitioners will appreciate that entry of a PIN, or any other indicia described herein, may be performed by any means known in the art.

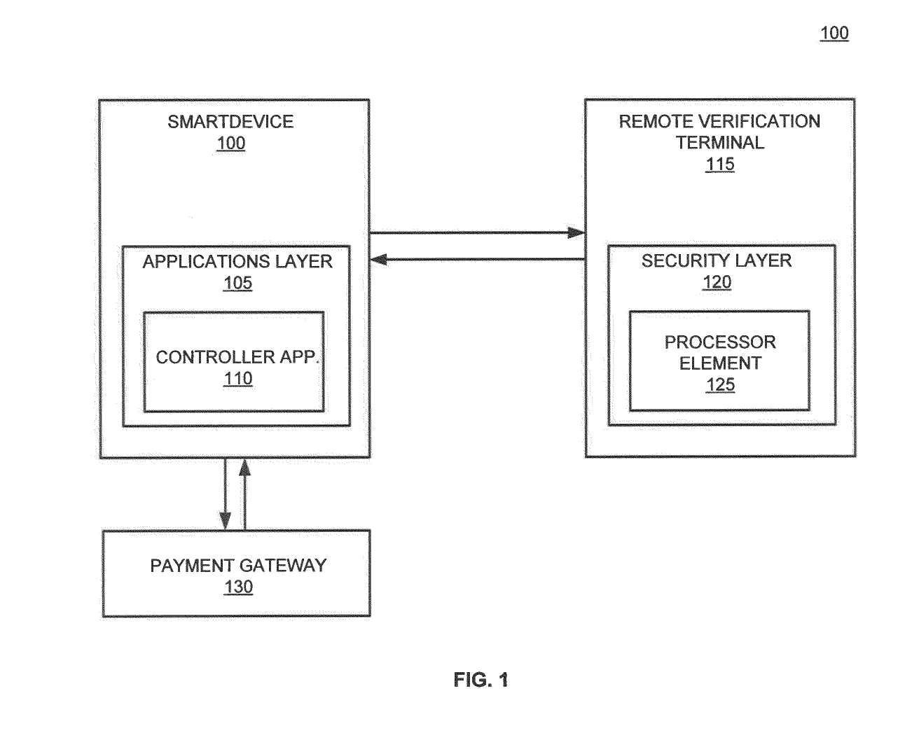

FIG. 1 is a system diagram illustrating system components for a remote verification terminal in accordance with an exemplary embodiment of the present invention. The remote verification terminal 115 implements both software and hardware security measures. In one embodiment, the remote verification terminal 115 may be viewed as a layered system including a hardware layer, operating system layer, application layer, security layer, etc. For simplicity, only the security layer 120 will be described relative to the software features of the remote verification terminal 115.

To secure any data that is to leave the confines of the remote verification terminal 115 to traverse a network, software is used to transform the data by way of highly secure encryption algorithms that are stored within a memory medium of the remote verification terminal 115. As such, hardware components including the memory medium are disposed within a tamper resistant case as a first line of defense. Those of ordinary skill in the art will appreciate that a number of methods exist for physically securing electronic devices from tampering. Such devices include, for example, complex devices, which render themselves inoperable what tampering is detected. A software technique for securing the remote verification terminal 115, for example, includes encrypting of all data transmissions between individual chips within the device.

Support for any currently known or future implementation of encryption and hashing algorithms may be supported by the disclosed remote verification terminal. Such encryption and hashing algorithms include, for example, DES, 3DES, AES-128, AES-192, AES-256, RSA, ECC, SHA-1, SHA-256, SHA-384, and the like.

In one embodiment, the remote verification terminal 115 includes tamper-resistant components to store and process private or sensitive information such as, for example, PINs, transaction card numbers, private keys, etc. Specifically, a security layer 120 is implemented to prevent an attacker from retrieving or modifying the information that is processed and/or stored by the remote verification terminal. Tamper-resistant components are configured such that the information is not accessible through external means and can only be accessed by the embedded software, which itself implements appropriate security measures.

The hardware and software implemented tamper-resistant components may be designed to zeroise sensitive data (i.e., cryptographic keys) if penetration of their security encapsulation or out-of-specification environmental parameters are detected. In another embodiment, the tamper-resistant components are configured for “cold zeroisation”, wherein a component has the ability to zeroise itself even after its power supply has been interrupted. Moreover, the tamper-resistant components may be designed in such a manner that they are internally pre-stressed, so the chip will fracture if interfered with.

In one embodiment, the remote verification terminal 115 includes components to facilitate bi-directional communication with a smartdevice 100. The remote verification terminal 115 does not itself connect to a public network, therefore payment authorization requests are managed by the smartdevice such that requests are originated at and transmitted to a payment gateway 110 over a public network by the smartdevice 100. In one embodiment, the smartdevice 100 includes a controller application 110 in the smartdevice's applications layer 105. The controller application 110 is configured to manage communications between data received either from the verification terminal 115 or other networked devices and systems, such as the payment gateway 110. Accordingly, hardware layer and operating system layers of the smartdevice 100 receive messages received from the payment gateway 110 and route it to the controller application 110 for processing. Moreover, the smartdevice 100 sends a connection request originating at the controller application 110 to the remote verification terminal 100.

Those of ordinary skill in the art will appreciate that the controller application 110 is presented herein as comprising a single entity residing in the applications layer 105 of the smartdevice 100. This is for simplifying the description of the features performed by the logic of the controller application 110 or its various components. However, the controller application 110 may also comprise several components residing within the same or different layers of the smartdevice infrastructure.

In one embodiment, a processor element 125 of the remote verification terminal 115 is configured to receive the connection request from a disparately located smartdevice 100 by way of a wired or wireless communications network. The connection request originates at the smartdevice controller application 110 in response to, for example, a merchant selecting a “Credit” or “Debit” button in a remote payment user interface. The connection request seeks to establish a secure communications channel between the smartdevice 100 and the remote verification terminal 115. In one embodiment, the connection request may include credentials relating to the merchant, smartdevice 100, or both.

In one embodiment, the merchant may be prompted to enter an authentication credential, such as a password. The authentication credential may be encrypted and transmitted to the remote verification terminal 115 to authenticate the merchant and thereby establish a secure communications channel between the remote verification terminal 115 and the smartdevice 100. In another embodiment, the smartdevice 100 sends a unique device identifier to the remote verification terminal 115 in order to ensure that the connecting smartdevice 100 is authorized to communicate with the remote verification terminal 115. In still another embodiment, both the merchant credential and device identifier are sent to the remote verification terminal 115 in order to ensure that both the merchant and the smartdevice 100 are authorized to request transaction card and cardholder verification. On successful verification of the credential(s) a secure communications channel is established between the remote verification terminal 115 and the smartdevice 100.

In one embodiment, the secure communications channel is based on the Secure Communications Interoperability Protocol (SOP), which is a multinational standard for secure voice and data communication. SCIP derived from the US Government Future Narrowband Digital Terminal (FNBDT) project and it supports a number of different modes, including national and multinational modes employing different types of cryptography.

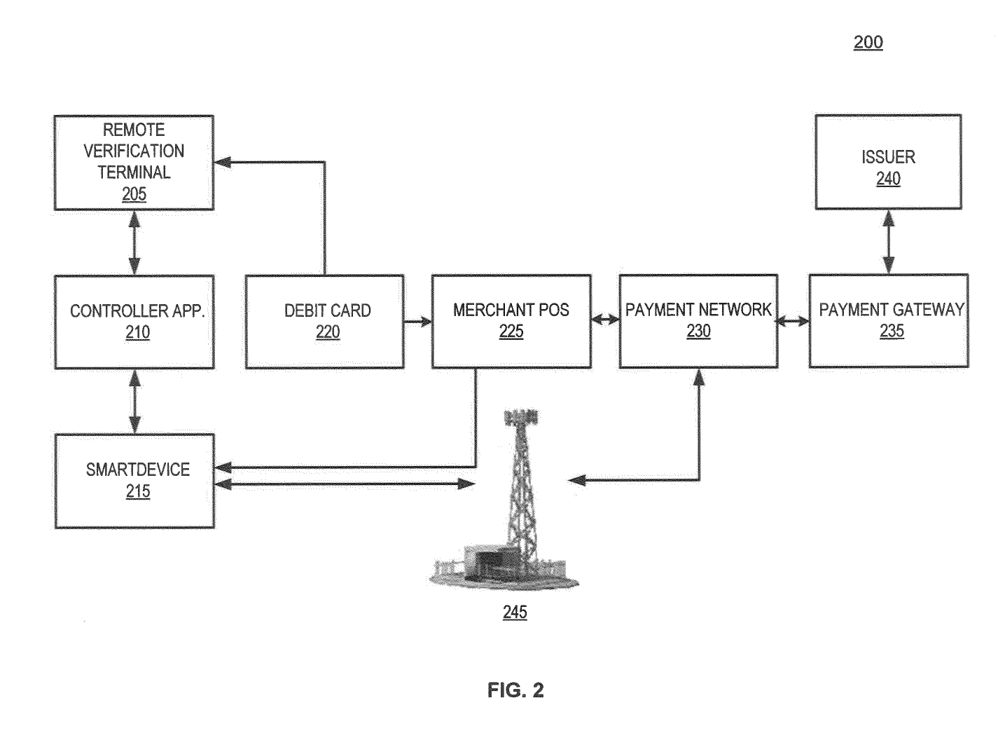

FIG. 2 is a network diagram illustrating the various devices and systems used in facilitating secure mobile transaction card payments with a remote verification terminal in accordance with an exemplary embodiment of the present invention. In one embodiment, the remote verification terminal 205 may be configured to operate with a wide variety of communications systems, including several different cellular telephone standards. As such, the remote verification terminal 205 may employ SCIP, which is indifferent to the underlying channel other than a minimum bandwidth of 2400 Hz. Using SCIP, the remote verification terminal 205 and the smartdevice 215 first negotiate the required parameters prior to selecting the optimal communication mode.

In one embodiment, a subset of transaction card information that is read and verified by the remote verification terminal 205 is sent across the secure communications channel to the smartdevice 215 by way of the controller application 210. The controller application 210 uses this subset of transaction card data to formulate an authorization request to transmit to a payment gateway 230. To further ensure the integrity of transaction card data leaving the remote verification terminal 205, an encryption technique is applied to the data. The applied encryption method may include any known and/or future encryption methodologies.

To accommodate validation processes for both PIN-less credit/charge cards as well as PIN-based debit cards 220, the remote verification terminal 205 is configured to facilitate a two tier verification process. In a first-tier of the verification process, the remote verification terminal 205 includes a card reader for receiving information that is encoded within a memory medium of the transaction card 220. The second-tier of the verification process receives a cardholder entered PIN and processes it to compare the PIN data with information collected during execution of the first-tier, in other words, data encoded within the transaction card 220 may include information for validating a PIN that is directly associated with the transaction card 220.

The most widely used type of transaction card 220 includes a magnetic stripe that maintains encoded information comprising, for example, a transaction account identifier. However, the remote verification terminal 205 may be equally effective in validating other types of transaction cards 220 implementing varying data storage architectures. One such transaction card type that is presently utilized in various markets is a smartcard. A typical smartcard includes a microprocessor and volatile memory for storing program instructions as well as data for identifying an account holder, a transaction account identifier, etc. In one embodiment, the remote verification terminal 205 is configured to support known transaction card configurations including traditional magnetic strip, traditional EMV, track data via NFC, EMV protocol through NFC, or a combination thereof.

In one embodiment, the card reader portion of the remote verification terminal 205 comprises a magnetic stripe reader, wherein an encoded transaction card is “swiped” such that the magnetic stripe of the transaction card slides across a remote verification terminal 205 reader head. The reader head is configured to detect and read data that has been encoded within the magnetic stripe. In another embodiment, the remote verification terminal includes a Near Field Communications (“NFC”) receiver, wherein data may be read from a microchip embedded within the structure of the transaction card 220 without requiring physical contact between the card and the receiver.

In various other embodiment, the remote verification terminal 205 includes one or more reader configurations, which are each capable of obtaining data from transaction cards 220, wherein the transaction cards may implement varying encoding and/or data storage architectures. A smartcard reader equipped remote verification terminal 205, for example, may include a slot for inserting a smartcard into the remote verification terminal housing. A number of contacts within the remote verification terminal interface conductive pads on the smartcard, thereby opening circuits between the electronic components of smartcard and the hardware components of the remote verification terminal.

The second-tier of the validation process is facilitated by way of a manual data entry panel positioned on the remote verification terminal 205. In one embodiment, the remote verification terminal 205 comprises a top surface and bottom surface, wherein the top surface includes a card reader for facilitating the first-tier verification and the bottom surface includes the PIN entry keypad for facilitating the second-tier verification. However, those of ordinary skill in art will appreciate that this is merely one of any number of possible physical configurations for the remote verification terminal 205. Specific physical arrangements are disclosed herein for the purpose of explanation only and are not intended to limit the scope of the invention in any way.

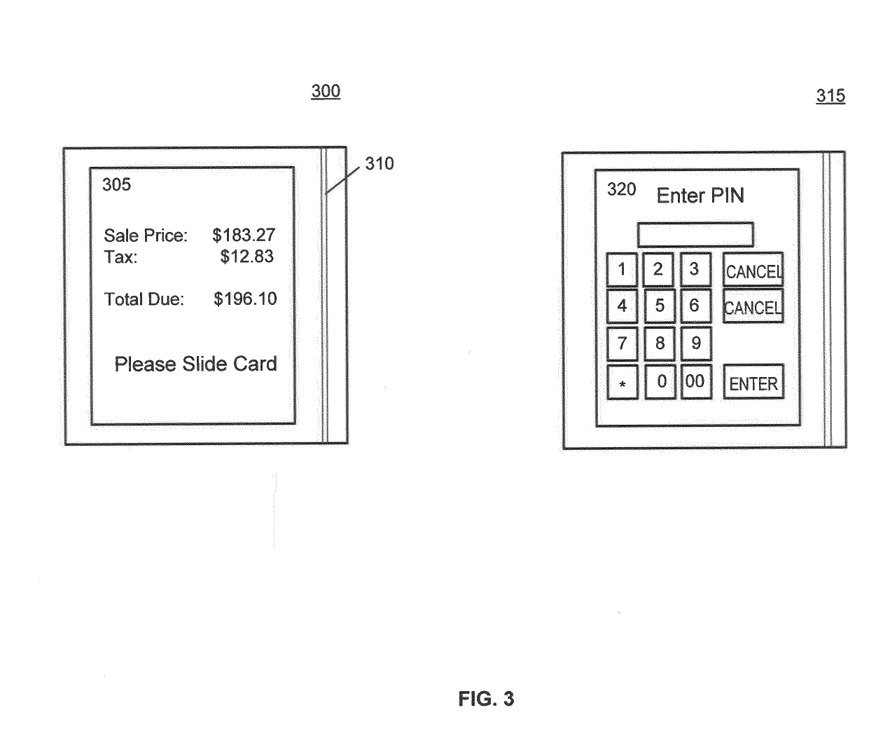

FIG. 3 is a device diagram illustrating a handheld remote verification terminal in accordance with an exemplary embodiment of the present invention. In one embodiment, the remote verification terminal 300 includes a display 305 (e.g., LED, LCD, e-paper, etc.) and a keypad 320 comprising a plurality of keys. Each of the plurality of keys correspond to a numeral ranging from 0 to 9, as well as additional keys labeled in accordance with their corresponding functions including, for example, “Clear”, “Cancel”, and “Enter.” The display 305 is configured to display prompts (e.g., “Enter PIN”) and messages (e.g., “Invalid PIN”). Further, the display may render the value for each cardholder selected key or it may simply display a placeholder character (e.g., “*”) to indicate that the key selection was registered while not revealing the selected key value. In one embodiment, the remote verification terminal 300 does not include mechanical keys. Instead, a keypad is rendered on a touch screen 320 as a graphical user interface.

In one embodiment, the remote verification terminal 300 includes a magnetic strip reader 310, or any other type of transaction card reader (e.g., smartcard). In accordance with this embodiment, the remote verification terminal 300 may be used with a smartdevice smartphone) to facilitate “card present” transactions with merchants over the Internet. However, in other embodiment described herein, the remote verification terminal 300 does not include a card reader such that the PIN security layer is segregated from the card data security layer.

To prevent observers from determining a cardholder's PIN by analyzing the movement of the cardholder's hand over the keypad, the remote verification terminal 300 may include a shield (not illustrated) that partially covers the keypad such that it is obstructed from the view of potential fraudsters. The keypad shield may further serve to improve screen visibility in environments having intense lighting. In one embodiment, the display may be fitted with a privacy screen or manufactured with a filter that restricts visibility to a specific viewing direction and angle.

To comply with the American Disabilities Act, the keys or touch screen 320 may provide tactile feedback, such as a subtle vibration when a key is presses. Moreover, the keys may include a brail representation of the corresponding key value. In other embodiments, the keypad 320 may generate sounds or verbal instructions to prompt the cardholder to, for example, swipe their transaction card and enter their PIN.

With reference to FIG. 2, the remote verification terminal 205 may facilitate debit type transaction either in an online environment or may be used by a merchant to serve as a remote means for processing purchase transactions when standard POS equipment is not available. In accordance with this embodiment, authorization requests are originated at the smartdevice 215 and transmitted to a payment gateway 230 by way of a transmission gateway 245, such as a cellular network. An authorization request traverses the payment network 230 in the conventional manner where it is routed to the appropriate issuer 240 by the payment gateway 235.

In one embodiment, the remote verification device 205 may reside as a consumer device to facilitate a debit-type transaction with a merchant without ever exposing the card information to the merchant POS 225. In another embodiment, a debit card 220 magnetic strip is read by the merchant POS 225. The PIN corresponding to the debit card 220 is entered at the remote verification device, which receives card information from the smartdevice 215. The smartdevice 215 receives information from the merchant POS 225 based on a negotiated secure channel between the two devices. The remote verification terminal 205 verifies the PIN in light of the merchant POS 225 supplied information and sends either an authorization or decline message to the merchant POS 225. The merchant POS 225 then constructs and sends and authorization request to the payment network 230 when the PIN is verified.

Communication between various entities of the invention is accomplished through any suitable communication means, such as, for example, a telephone network, intranet, Internet, payment network, online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, decryption, compression, decompression, and/or the like.

A transaction card 220 may communicate to the merchant, information from one or more data sets associated with the transaction card 220. In one example, membership data and credit/debit card data associated with a transaction account or device may be transmitted using any conventional protocol for transmission and/or retrieval of information from an account or associated transaction card (e.g., credit, debit, gift, stored value, loyalty, etc,). In another embodiment, a transaction card 220 may comprise an electronic coupon, voucher, or other such instrument. In yet another embodiment, the transaction card 220 may be configured to communicate via Radio Frequency (RF) signals. As such, the data maintained by the transaction card 220 may be communicated via RF signals.

The transaction card 220 in accordance with this invention may be used to pay for acquisitions, obtain access, provide identification, pay an amount, receive payment, redeem reward points, and/or the like. In the RF embodiments, instrument to instrument transactions may also be performed. See, for example, Sony's “Near Field Communication” (“NFC”) emerging standard which is touted as operating on 13.56 MHz and allowing the transfer of any kind of data between NFC enabled devices and across a distance of up to twenty centimeters. See also, Bluetooth chaotic network configurations; described in more detail at http://www.palowireless.com/infotooth/whatis.asp, which is hereby incorporated by reference. Furthermore, data on a first RF device may be transmitted directly or indirectly to a second RF device to create a copy of all or part of the original device.

The transaction card 220 may be associated with various applications which facilitate participation in various programs such as, for example, loyalty programs. A loyalty program may include one or more loyalty accounts. Exemplary loyalty programs include frequent flyer miles, on-line points earned from viewing or purchasing products or websites on-line and programs associated with diner's cards, credit cards, debit cards, hotel cards, calling cards, and/or the like.

As disclosed herein, a transaction card 220 is normally associated with a transaction account. Generally, the user is both the owner of the transaction account and the participant in the loyalty program; however, this association is not required. For example, a participant in a loyalty program may gift loyalty points to a user who pays for a purchase with his own transaction account, but uses the gifted loyalty points instead of paying the monetary value.

The transaction card 220 maintains a transaction account identifier linking the transaction card to a transaction account. A “transaction account identifier”, “code,” “account,” “account number,” “account code”, “identifier,” “loyalty number” or “membership identifier,” as used herein, includes any device, code, or other identifier/indicia suitably configured to allow the consumer to interact or communicate with the system such as, for example, authorization/access code, Personal Identification Number (PIN), Internet code, other identification code, and/or the like that is optionally maintained on and/or by a NACV module, SIM card, rewards card, charge card, credit card, debit card, prepaid card, telephone card, smart card, magnetic strip card, bar code card, radio frequency card and/or the like.

The transaction account identifier may be distributed and stored in any form of plastic, electronic, magnetic, radio frequency, audio and/or optical device capable of transmitting or downloading data from itself to a second device. A transaction account identifier may be, for example, a sixteen-digit credit card number, although each credit provider has its own numbering system, such as the fifteen-digit numbering system used by an exemplary loyalty system. Each provider's credit/debit card numbers comply with that provider's standardized format such that the provider using a sixteen-digit format may generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. In addition, loyalty account numbers of various types may be used.

The “transaction information” in accordance with this invention may include the nature or amount of transaction, as well as, a merchant, user, and/or issuer identifier, security codes, routing numbers, and the like. In various exemplary embodiments, one or more transaction accounts may be used to satisfy or complete a transaction. For example, the transaction may be only partially completed using the transaction account(s) correlating to the application tenant information stored on the transaction card with the balance of the transaction being completed using other sources. Cash may be used to complete part of a transaction and the transaction account associated with a user and the transaction card, may be used to satisfy the balance of the transaction. Alternatively, the user may identify which transaction account, or combination of transaction accounts, the user desires to complete a transaction. Any known or new methods and/or systems configured to manipulate the transaction account in accordance with the invention may be used.

In various exemplary embodiments, the transaction card may be embodied in form factors other than, for example, a card-like structure. As previously noted, the transaction card may comprise a RF transponder, a speed pass, store discount card, or other similar device. The transaction card may furthermore be associated with coupons. A typical RF device which may be used by the present invention is disclosed in U.S. application Ser. No. 12/553,901, entitled “System and Method for Facilitating Secure Voice Communication Over a Network”, which is commonly assigned, and which is hereby incorporated by reference.

One skilled in the art will appreciate that a network may include any system for exchanging data or transacting business, such as the Internet, an intranet, an extranet, WAN, LAN, satellite communications, cellular network, and/or the like. It is noted that the network may be implemented as other types of networks such as, for example, an interactive television (ITV) network. The users may interact with the system via any input device such as a keyboard, mouse, kiosk, personal digital assistant (e.g., Palm Pilot®), handheld computer, cellular phone, and/or the like. Similarly, the invention may be used in conjunction with any type of personal computer, network computer, workstation, minicomputer, mainframe, or the like running any operating system such as any version of Windows, Windows XP, Windows Vista, Windows NT, Windows 2000, Windows 98, Windows 95, Android, Google Chrome, MacOS, OS/2, BeOS, Linux, UNIX, Solaris, or the like. Moreover, although the invention is frequently described herein as being implemented with specific communications protocols, it may be readily understood that the invention could also be implemented using HTTP, TCP/IP, SMTP, Bluetooth, IPX, AppleTalk, IP-6, NetBIOS, OSI or any number of existing or future protocols. Moreover, the system may contemplate the use, sale or distribution of any goods, services or information over any network having similar functionality described herein.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc,); block of binary (BLOB); stored as ungrouped data elements encoded using ISO/EEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Binary Large Object (BLOB). Thus, any binary information may be stored in a storage space associated with a data set. As discussed above, the binary information may be stored on the financial transaction card or external to but affiliated with the financial transaction card. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data associated with the financial transaction card by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data, which also may be distinct from other subsets.

The data set annotation may be used for various types of status information as well as other purposes. For example, the data set annotation may include security information establishing access levels. The access levels may, for example, be suitably configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The present invention may be described herein in terms of functional block components, optional selections and/or various processing steps. It should be appreciated that such functional blocks may be realized by any number of hardware and/or software components suitably configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), Microsoft.Net with the various algorithms being implemented with any combination of data structures, objects, processes, routines or other programming elements. Further, it should be noted that the present invention may employ any number of conventional techniques for data transmission, messaging, data processing, network control, and/or the like. Still further, the invention could be used to detect or prevent security issues with a client-side scripting language, such as JavaScript, VBScript or the like. For a basic introduction of cryptography and network security, the following may be helpful references; (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security; Principles & Practice” by Mayiam Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical transaction card distribution system.

As may be appreciated by one of ordinary skill in the art, the present invention may be embodied as a method, a data processing system, a device for data processing, a financial transaction card, and/or a computer program product. Accordingly, the present invention may take the form of an entirely software embodiment, an entirely hardware embodiment, or an embodiment combining aspects of both software and hardware or other physical devices. Furthermore, the present invention may take the form of a computer program product on a tangible computer-readable storage medium having computer-readable program code means embodied in the storage medium. Any suitable tangible computer-readable storage medium may be utilized, including hard disks, CD-ROM, optical storage devices, magnetic storage devices, and/or the like.

These computer program instructions may also be stored in a computer-readable memory that may direct a computer or other programmable data processing apparatus to function in a particular manner, such that the instructions stored in the computer-readable memory produce an article of manufacture including instruction means which implement functions of flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions specified in the flowchart block or blocks.

In the foregoing specification, the invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A method for facilitating a financial transaction, the method comprising:
establishing a secure communication channel between a remote communication device and a remote verification terminal;
receiving, at the remote verification terminal, a request to verify a transaction instrument and an identity of a cardholder;
receiving, at the remote verification terminal, a Personal Identification Number (PIN);
receiving, at the remote verification terminal, encoded transaction information for the financial transaction;
processing, by the remote verification terminal, the PIN to verify that the PIN corresponds to the encoded transaction information; and
sending, by the remote verification terminal, a verification message to the remote communication device by way of the secure communication channel when the correspondence between the PIN and the encoded transaction information is verified.
